(19) United States
(12) Patent Application Publication
(10) Pub. No.: US 2013/0083823 A1
(43) Pub. Date: Apr. 4, 2013

(54) ELECTRONIC THERMOMETER WITH IMAGE SENSOR AND DISPLAY

(71) Applicant: Covidien LP, Mansfield, MA (US)

(72) Inventors: James M. Harr, Foristell, MO (US); Robert B. Gaines, Lake Saint Louis, MO (US); John Holste, Hamburg, IL (US)

(73) Assignee: COVIDIEN LP, Mansfield, MA (US)

(21) Appl. No.: 13/630,108

(22) Filed: Sep. 28, 2012

Related U.S. Application Data
(60) Provisional application No. 61/540,755, filed on Sep. 29, 2011.

(51) Int. Cl. G01J 5/02

(52) U.S. Cl. 374/121

(57) ABSTRACT

A thermometer for measuring a temperature of a subject. The thermometer includes a probe for insertion into an orifice of the subject. An electromagnetic radiation sensor at the probe senses electromagnetic radiation within the orifice of the subject. The electromagnetic radiation sensor generates data indicative of both the temperature of the subject and one or more anatomical images of the subject. A controller receives the data from the electromagnetic radiation sensor. The controller generates a temperature image on the display indicative of the computed temperature of the subject and one or more anatomical images of the subject on the display.

### RELATED APPLICATIONS

This application claims the benefit under 35 U.S.C. 120 to co-pending U.S. Patent Application Ser. No. 61/540,755 filed on Sep. 29, 2011, entitled, THERMOMETER WITH CAMERA AND VIDEO DISPLAY, which is incorporated herein by reference in its entirety for all purposes.

### BACKGROUND

Aspects of the present invention generally relate to thermometers, and more particularly to an electronic thermometer having a camera and a video display.

Medical thermometers are typically employed to measure a subject's body temperature to facilitate the prevention, diagnosis, and treatment of diseases, body ailments, etc., for humans and other animals. An accurate reading of a subject's body temperature is required for effective use and should be taken from the internal or core temperature of a subject's body. Several thermometer devices are known for measuring a subject's body temperature, such as, for example, electronic thermometers, including tympanic thermometers.

Many tympanic thermometers have a sensing probe that is inserted into a subject's orifice (e.g., ear) for measuring the subject's body temperature. The sensing probe includes an electromagnetic radiation sensor, such as a thermopile for sensing infrared emission from the tympanic membrane, or eardrum. During use, the thermopile is generally located inside the ear canal. The thermopile may utilize a waveguide of radiant heat to transfer heat energy from the tympanic membrane to the sensor. Conventionally, the probe is inserted “blindly” into the ear canal, whereby the user cannot visualize the anatomy of the inner ear, cannot determine the depth at which the probe is inserted in the ear, and cannot determine if the sensing probe is accurately sensing the infrared emitting from the tympanic membrane.

### SUMMARY

In a first aspect, a thermometer for measuring a temperature of a subject generally comprises a probe adapted to be inserted into an orifice of the subject. An electromagnetic radiation sensor at the probe senses electromagnetic radiation within the orifice of the subject. The electromagnetic radiation sensor is configured to generate data indicative of both the temperature of the subject and one or more anatomical images of the subject. The thermometer includes a visual display. A controller, including a processor, is in communication with the electromagnetic radiation sensor and the visual display and is configured to: receive the generated data from the electromagnetic radiation sensor; compute the temperature of the subject based on the received generated data; generate a temperature image on the display indicative of the computed temperature of the subject; compute one or more anatomical images of the subject based on the received generated data; and generate the one or more computed anatomical images of the subject on the display.

In another aspect, a tympanic thermometer for measuring a temperature of a subject generally comprises a handle sized and shaped to be held by a user, a visual display on handle, and a probe extending outward from the handle and adapted to be inserted into an ear canal of the subject. An infrared radiation temperature sensor in the probe senses infrared radiation emitting from a tympanic membrane of the subject when the probe is inserted in the ear canal of the subject. The infrared radiation temperature sensor is configured to generate temperature data indicative of the temperature of the subject. A visible light image sensor at the probe senses visible light radiation reflecting from ear canal when the probe is inserted in the ear canal of the subject. The visible light image sensor is configured to generate anatomical image data indicative of the anatomy of the subject. A controller, including a processor, is in communication with the infrared radiation temperature sensor, the visible light sensor, and the visual display. The controller is configured to: receive the generated temperature data from the infrared radiation temperature sensor; compute the temperature of the subject based on the received temperature data; generate a temperature image on the display indicative of the computed temperature of the subject; receive the generated anatomical image data from the visible light image sensor; and generate one or more anatomical images of the subject on the display based on the received image data.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a perspective view of a tympanic thermometer, in accordance with the principles of the present disclosure, mounted on a holder;

FIG. 2 is a perspective view of the tympanic thermometer shown in FIG. 1 with a probe cover disposed on a distal end of the thermometer;

FIG. 3 is a perspective view of the probe cover shown in FIG. 2;

FIG. 4 is an exploded perspective view of the distal end of the tympanic thermometer shown in FIG. 2;

FIG. 5 is a cross-sectional and fragmentary view of the probe of the tympanic thermometer, including the probe cover;

FIG. 6 is a block diagram illustrating aspects of the thermometer;

FIG. 7 is a cross-sectional and fragmentary view of a second embodiment of probe of the tympanic thermometer, including the probe cover;

FIG. 8 is a cross-sectional and fragmentary view of a third embodiment of probe of the tympanic thermometer, including the probe cover;

FIG. 9 is a schematic of a display of the tympanic thermometer including an anatomical visual image and a temperature image overlaying the anatomical visual image;

FIG. 10 is similar to FIG. 9, except the temperature image does not overlay and the anatomical visual image;

FIG. 11 is a schematic of a display of the tympanic thermometer including an anatomical infrared image and a temperature image overlaying the anatomical infrared image;

FIG. 12 is similar to FIG. 11, except the temperature image does not overlay and the anatomical infrared image; and

FIG. 13 is a cross-sectional and fragmentary view of a third embodiment of probe of the tympanic thermometer, including the probe cover.

Corresponding reference characters indicate corresponding parts throughout the drawings.

### DETAILED DESCRIPTION

The exemplary embodiments of an electronic thermometer and methods of use disclosed are discussed in terms of medical thermometers for measuring body temperature and, more particularly, in terms of a tympanic thermometer that includes a temperature sensor for measuring body temperature when the thermometer is inserted into an ear of a subject. But the disclosed elements can be used with other types of electronic thermometers without departing from the scope of the present invention.

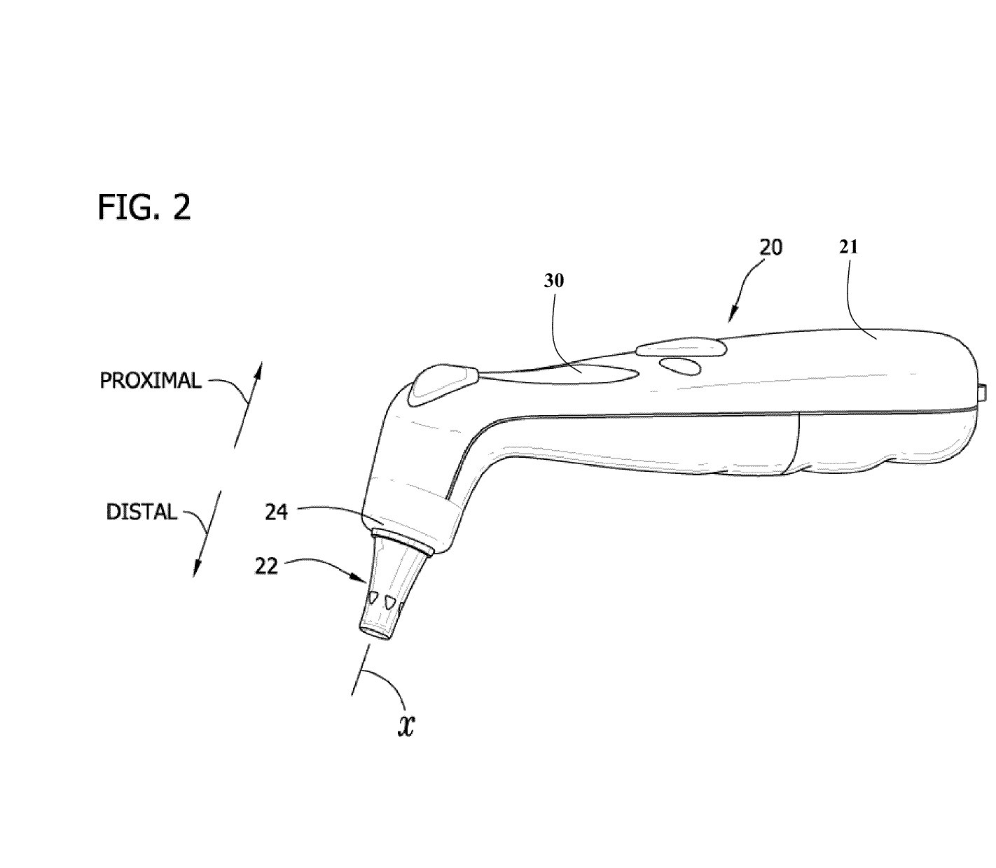

In the discussion that follows, the term “proximal” will refer to the portion of a structure that is closer to a practitioner, while the term “distal” will refer to the portion that is farther from the practitioner. FIG. 2 illustrates “proximal” and “distal” for the structure, which is the fully assembled and usable tympanic thermometer. As-used herein, the term “subject” refers to a human patient or other animal having its body temperature measured. According to the present disclosure, the term “practitioner” refers to a doctor, nurse, parent, or other care provider utilizing a tympanic thermometer to measure a subject's body temperature, and may include support personnel.

Aspects of the present invention relate to an electronic thermometer and, more particularly, to an electronic tympanic thermometer including a probe for insertion into an ear canal (broadly, an orifice) of the subject, a temperature sensor in the probe, and a camera (broadly, an image sensor) adjacent a distal end of the probe. The camera detects or senses one or more types of electromagnetic radiation (e.g., visible light, infrared radiation, etc.) from within the ear and converts the sensed radiation to image data that is indicative of one or more anatomical images of the inside of the subject's ear. In one embodiment, the electronic thermometer includes an image display for displaying the image(s) generated from the anatomical image data. Moreover, a temperature image indicating a temperature computed by the thermometer may be displayed on the display, such as superimposed over the image(s) of the inside of the subject's ear.

In one embodiment, the image sensor comprises an infrared (IR) image sensor for generating image data relating to the sensed IR radiation emitting from the inside of the patient's ear (e.g., IR radiation emitting from the patient's tympanic membrane). In another embodiment, the image sensor comprises a visible light image sensor for generating image data relating to the sensed visible light from inside the patient's ear. In yet another embodiment, the electronic thermometer includes both an IR image sensor and a visible light image sensor, and a switch for selecting between two modes of operation: one mode for displaying an IR image (e.g., a thermal image) and another mode for displaying a visible image.

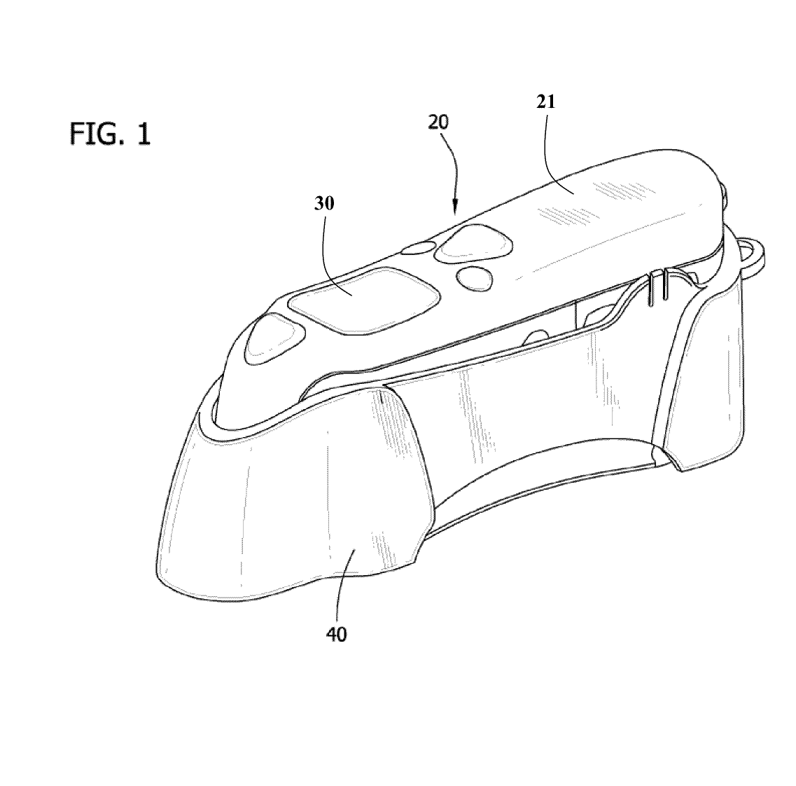

Reference will now be made in detail to exemplary embodiments of the present disclosure, which are illustrated in the accompanying Figures. Turning now to the Figures and initially to FIGS. 1 and 2, there is illustrated a tympanic thermometer, generally indicated at 20, in accordance with the principles of the present disclosure. It is contemplated that the tympanic thermometer 20 includes the necessary electronics and/or processing components to perform temperature measurement via the tympanic membrane, as is known to one skilled in the art. It is further envisioned that tympanic thermometer 20 may include a waveguide to facilitate sensing of the tympanic membrane heat energy. However, in the illustrated embodiments, the waveguide is beneficially omitted.

The tympanic thermometer 20 is releasably mounted in a holder 40 for storage in contemplation for use. The tympanic thermometer 20 and holder 40 may be fabricated from semi-rigid, rigid plastic and/or metal materials suitable for temperature measurement and related use. It is envisioned that the holder 40 may include the electronics necessary to facilitate powering the tympanic thermometer 20, including, for example, battery charging capability, etc. The thermometer 20 is operable in a sleep mode wherein the thermometer 20 conserves energy and is not capable of performing a temperature measurement and an awake mode wherein the thermometer is operating at full power and is capable of performing a temperature measurement in certain conditions as will be described in greater detail below.

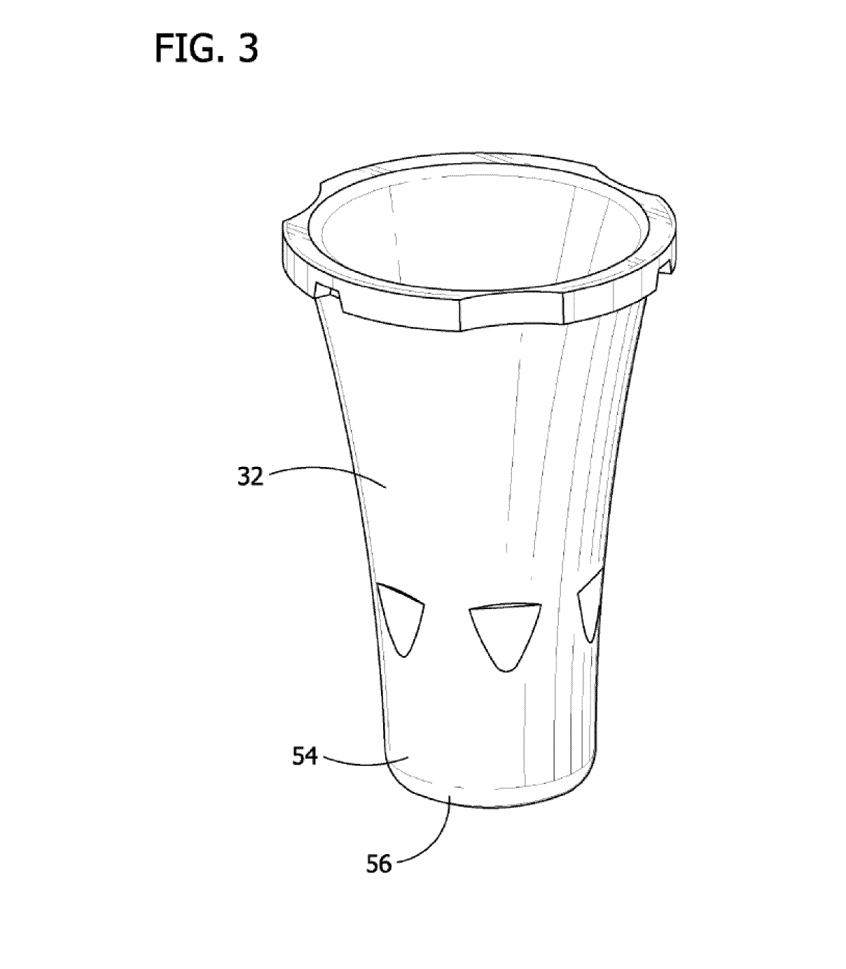

Referring to FIGS. 1-5, tympanic thermometer 20 includes a handle 21 (FIGS. 1 and 2), and probe, generally indicated at 22, extending outward distally from the handle. The probe 22 defines a longitudinal axis X. The probe 22 may have various geometric cross-sectional configurations, such as, for example, cylindrical, rectangular, elliptical, etc. The probe 22 is configured to be inserted into a subject's ear canal, although it is understood that the probe may be configured for insertion into other orifices of the subject.

A probe cover 32 may be disposed over the heat sensing probe 22. The probe cover 32 has a distal end 54 that is substantially enclosed by a film 56. The film is substantially transparent to infrared radiation and configured to facilitate sensing of infrared emissions by heat sensing probe 22. The film 56 is advantageously impervious to ear wax, moisture, and bacteria to prevent disease propagation. One skilled in the art, however, will realize that other materials and fabrication methods suitable for assembly and manufacture are also within the scope of the present invention. The probe cover 32 may be shaped, for example, frustoconically, or shaped in a tapered manner as to allow for easier insertion into the ear of the subject and attachment and detachment from the heat sensing probe 22. The probe cover 32, which is disposable, may be fabricated from materials suitable for measuring body temperature via the tympanic membrane with a tympanic thermometer measuring apparatus. These materials may include, for example, plastic materials, such as, for example, polypropylene, polyethylene, etc., depending on the particular temperature measurement application and/or preference of a practitioner.

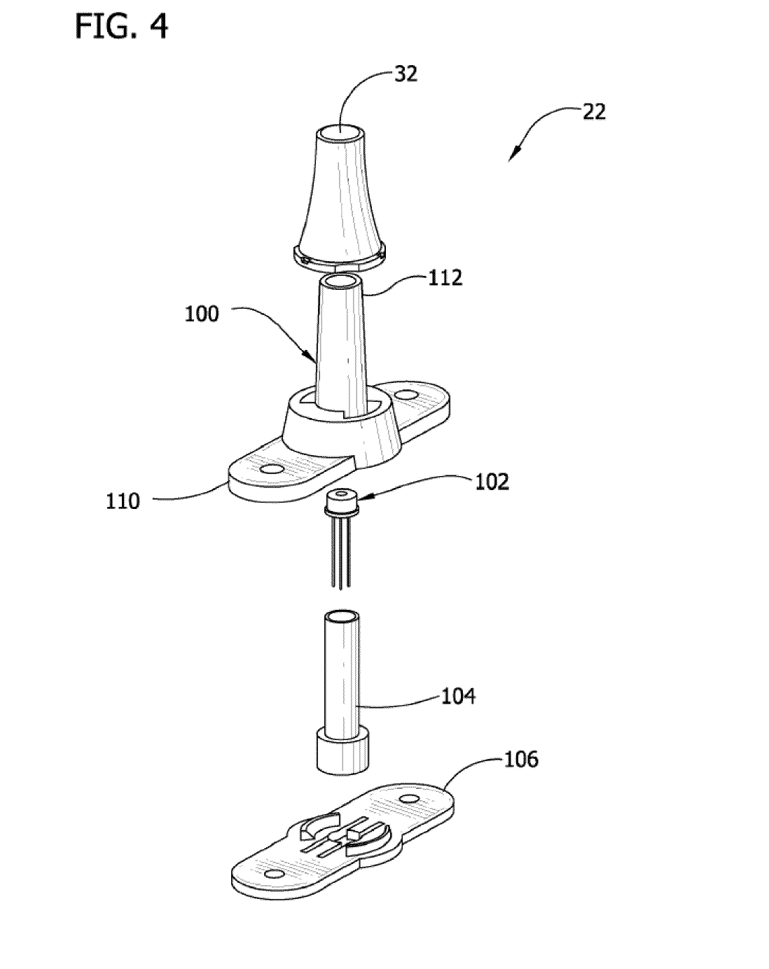

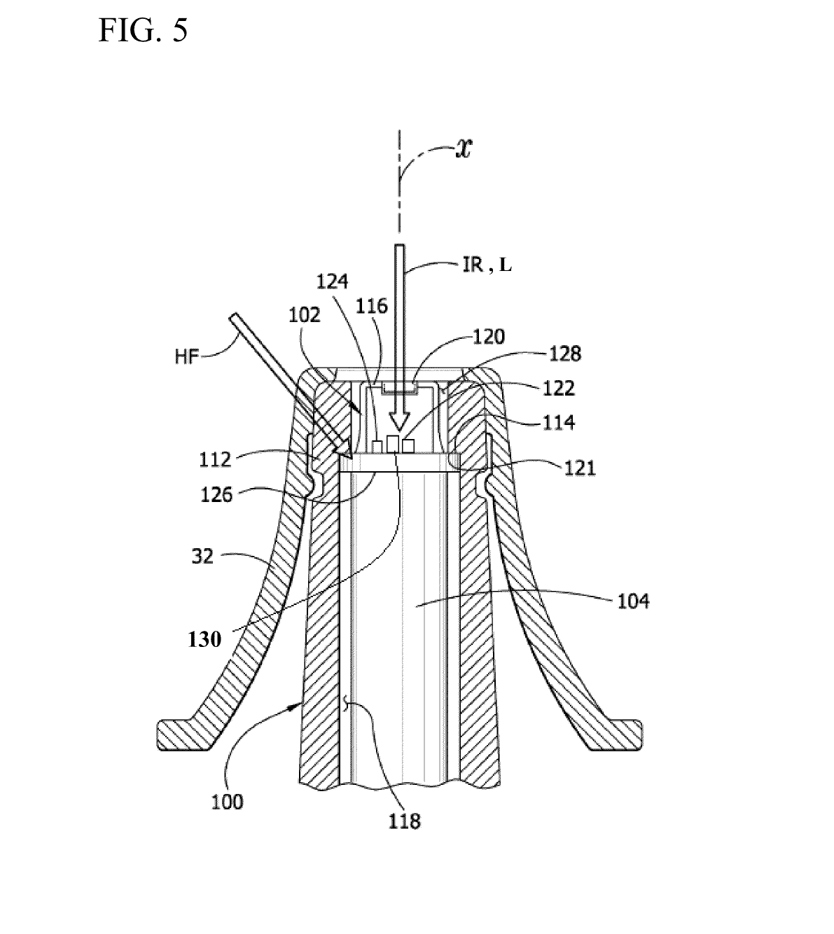

Referring to FIGS. 4 and 5, the probe 22 includes a nozzle, generally indicated at 100, mounted on a base 106. The nozzle 100 includes a base 110 and an elongated nose portion 112 projecting distally from the base. By way of non-limiting example, nozzle 100 may be fabricated from metal or other material which aides in the rapid exchange or transfer of heat. The nozzle 100 is formed of two parts (the base 110 and the nose portion 112) in the illustrated embodiment. It will be understood that a nozzle can be formed as one piece or more than two pieces without departing from the scope of the present invention. In particular, it is envisioned that the elongated nose section 112 can be formed of two or more pieces.

Referring still to FIGS. 4 and 5, the probe 22 includes a sensor can, generally indicated at 102, attached to temperature sensing electronics mounted on a distal end of a sensor housing 104 (or “retainer”) received within the nozzle 100. The can 102 includes a sensor base 126 and a generally inverted cup-shaped tip 116, including an infrared filter or window 120, mounted on the base. In the illustrated embodiment, there is an annular space 128 between the can 102 and the nose portion 112, and an annular space 118 between the sensor housing 104 and the nose portion. The sensor housing 104 is mounted on the base 106 of probe 22 such that it extends generally coaxially within nozzle 100. By way of non-limiting example, the sensor housing 104 is fabricated from materials that provide for less thermal transmission (i.e., more insulated) than the nozzle 100, for example, plastic or other similar matter. So the material of the sensor housing 104 has a low thermal conductivity as compared to the thermal conductivity of the nozzle 100 and the base 126 of the can 102.

In the illustrated embodiment of FIG. 5, a temperature sensor 122 (e.g., a thermopile), a reference temperature sensor (e.g., thermistor) 124, and an image sensor 130 are housed within the can 102, although it is understood that the respective sensors may be disposed in other locations of the probe 22 without departing from the scope of the present invention. For example, the image sensor 130 may be disposed on the exterior of the can 102 (e.g., at the distal end of the can). It is also understood that the reference temperature sensor 124 may be omitted without departing from the scope of the present invention.

The temperature sensor 122 detects or senses a temperature parameter of the subject (e.g., IR radiation emitted from the tympanic membrane) and generates temperature data based on the detected or sensed temperature parameter. The reference temperature sensor 124 detects or senses a temperature parameter of the can 102 and generates reference temperature data based on the detected or sensed reference temperature parameter. The image sensor 130 detects or senses radiation from within the subject's orifice (e.g., ear) and generates image data based on the detected or sensed radiation. Each of the sensors 122, 124, and 130 communicates with a control circuit or controller 132 of the thermometer 20. That is, the controller 132 receives the temperature data from the temperature sensor 122, the reference temperature data from the reference temperature sensor 124, and the image data from the image sensor 130. The controller 132, which includes a processor, is configured (i.e., programmed) to determine or compute a body temperature of the subject based on the received temperature data from the temperature sensor and the reference temperature data from reference temperature sensor.

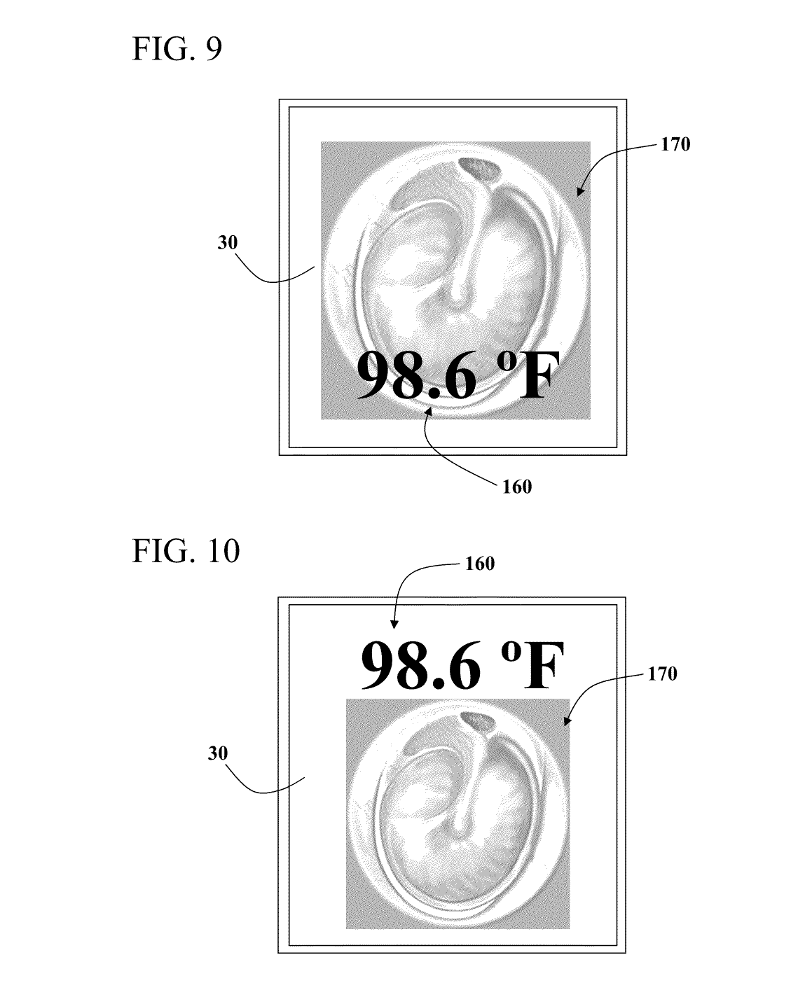

As shown in FIGS. 9-12, and explained in more detail below, the controller 132 generates a temperature image, generally indicated at 160, indicative of the computed body temperature on a display 30 on the thermometer 20, and the controller 132 is further configured (i.e., programmed) to compute an anatomical image (e.g., a video image or a still image) of the subject and generate the anatomical image, generally indicated at 170, on the display 30 (or another display, such as another display on the thermometer or a remote display) based on the image data received from the image sensor 130. The controller 132 may consist of a single controller in the thermometer 20, or in another embodiment the controller 132 may comprise more than one control circuit or controller. In such an embodiment, the multiple controllers 132 may be in communication with one another or the multiple controllers may operate independent of one another. Moreover, one or more of the controllers 132 may be located outside the body (e.g., the handle 21) of the thermometer 20.

Referring again to FIG. 5, in one embodiment, the temperature sensor 122 detects infrared (IR) radiation emitting from the subject's tympanic membrane, for example, that passes through the film 56 of probe cover 32 and enters the can 102 through the window 120 of probe 22. This infrared energy may heat the can 102 and create a temperature gradient across the tip 116 from its distal end to its proximal end contacting the base 126. That is, the distal end can be much warmer than the proximal end. In the illustrated embodiment, heat from, for example, the ear of the subject is transferred from probe cover 32 to nozzle 100 to the base 126 of the can 102 via a path of heat flux HF. The path of heat flux heats the can 102 in order to reduce the temperature gradient across tip 116. An internal ridge 121 engages a distal side of a peripheral edge margin 114 of the base 126 to provide a heat conducting path from the nozzle 100 to the base 126 defining the path of heat flux. It is contemplated herein that nozzle 100 may be both in physical contact with the peripheral edge margin 114 or in a close proximate relationship with the peripheral edge margin 114 of can 102. In other embodiments, the nozzle 100 may not be in thermal contact with the can 102 or there may be insulation between the nozzle and the can inhibit thermal contact as to restrict heat transfer from the internal ridge 121 of the nozzle 100 to the peripheral edge margin 114 of the base 126.

In one example, the reference temperature data generated by the reference temperature sensor 124 is used (e.g., analyzed) by the controller 132 to adjust (e.g., calibrate and/or compensate) the temperature data generated by the temperature sensor 122 in order to compute the temperature of the subject. In the illustrated embodiment, the reference temperature sensor 124 is adapted to detect the temperature of the base 126 of the sensor can 102. The reference temperature sensor 124 may be a thermistor or other temperature-sensing sensor.

In another embodiment, the image sensor 130 comprises a visible light image sensor for sensing radiation L in the visible light spectrum that is reflected (i.e., emitted) by the anatomy (e.g., inner ear) of the subject. The visible light image sensor 130 generates visible light data, and the controller 132 computes a visible anatomical image based on the visible light data and generates the image(s) (e.g., a video), of the anatomy of the subject 170 on the display 30. In one example, the display 30 comprises a video display that displays, for example, a live continuous stream of video generated by the controller 132 based on the visible light data received from the image sensor 130. In the embodiment including the visible image sensor 130, the visible image(s) 170 generated on the display 30 may inform the practitioner whether ear wax or another foreign object is present on the distal tip of the thermometer probe 22, provide visual cues to aid in controlling the insertion depth of the thermometer probe, and/or aid in determining whether the ear needs to be cleaned before a measurement is taken. Additionally, the visible images (e.g., video) may be used to train users so that they are able to develop an efficient and accurate technique for using a tympanic thermometer.

In one example, the controller 132 is configured to generate the temperature image 160 on the video display 30 based on the temperature data received from the temperature sensor 122 (e.g., the IR temperature sensor) and the reference temperature data received from the reference temperature sensor 124. The temperature image 160 (e.g., 98.6° F., as illustrated in FIGS. 9 and 10) is indicative of the temperature of the subject and may be superimposed over the video image 170 (e.g., as an overlay), as shown in FIG. 9. In another embodiment, such as shown in FIG. 10, the temperature image 160 and the video image 170 may be separated so that there is no overlay. It is also contemplated that the display 30 may include more than one display, including an image display for displaying anatomical images and a temperature display for displaying a temperature image indicative of the computed temperature of the subject. In the illustrated embodiment the display is associated with the handle 21 of the thermometer, however, in another example, instead of or in addition to video display 30, the thermometer 20 may be equipped with a wireless transmitter for sending still images, video signals, and/or temperature data to a remote display and/or to an electronic medical record system. This information may be useful for providing evidence of infections or other medical conditions.

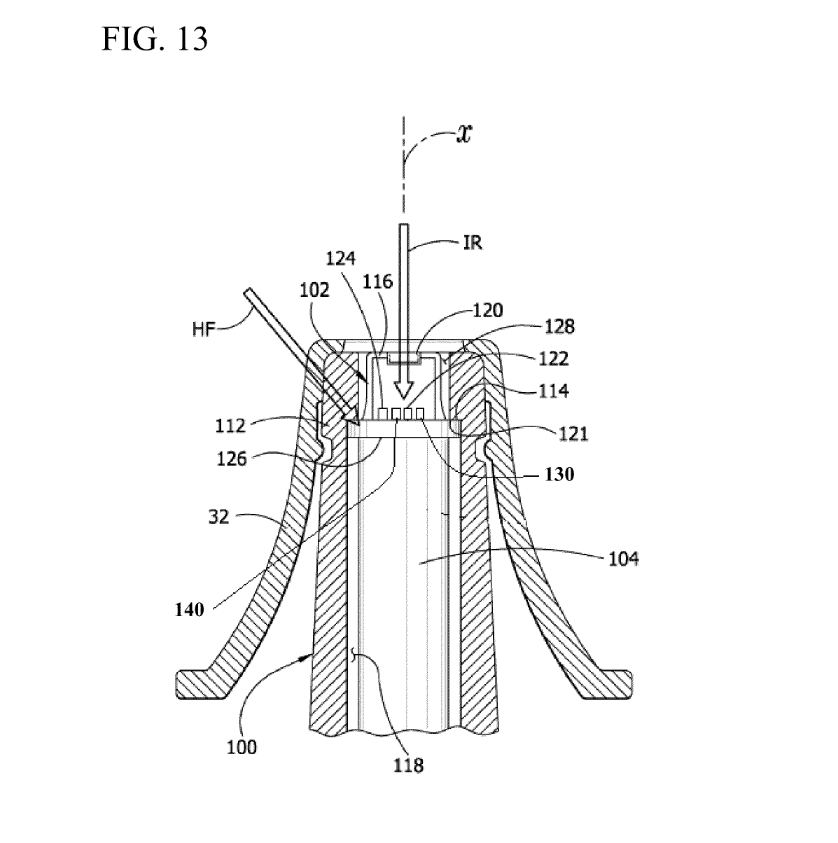

The embodiment shown in FIG. 13 is similar to the embodiment of FIG. 5 including the visible light image sensor 130, the reference temperature sensor 124, and the temperature sensor 122, as set forth above. In addition to these components, the embodiment of FIG. 13 includes a light source 140 (e.g., an LED) for illuminating the field of view of the visible light image sensor 130. In one embodiment, the light source 140 is in communication with the controller 132 so that the controller controls operation of the light source. In another embodiment, the light source may include a light pipe extending along the length of the probe for delivering light from a source adjacent the proximal end of the probe. Other ways of illuminating the field of view of the image sensor 130 do not depart from the scope of the present invention.

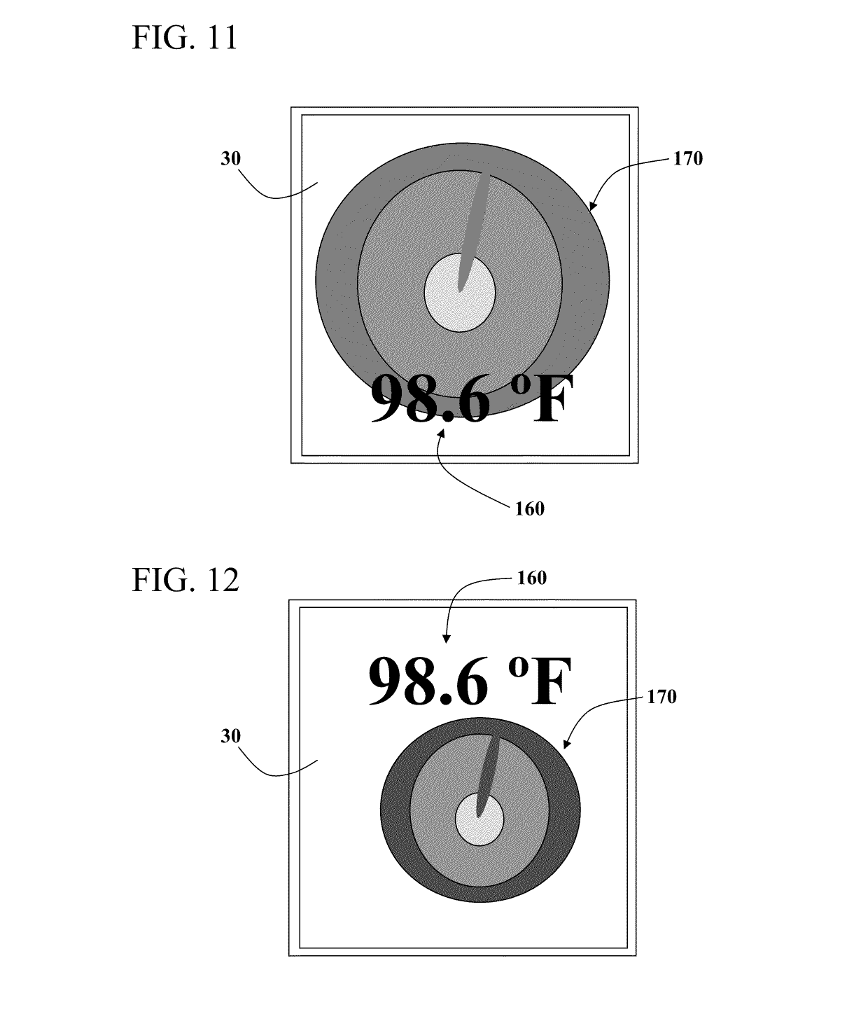

Referring to FIGS. 5, 11, and 12, in another embodiment the image sensor 130 is an infrared (IR) image sensor. The IR image 170 (e.g., thermal video) generated on the display 30, as shown in FIGS. 11 and 12, may be used to direct a user to the hottest part of the subject's tympanic membrane (as indicated by the lightest shaded area in FIGS. 11 and 12). The temperature image 160 (e.g., 98.6° F.) may be superimposed over the video image 170 (e.g., as an overlay), as shown in FIG. 11, or may be separate from the IR image so that there is no overlay, as shown in FIG. 12. The IR image sensor 130 may be used to identify ear wax or other obstructions in the field of view of the temperature sensor 120 (e.g., IR temperature sensor). Additionally, the incorporation of the IR image sensor 130 in the thermometer 20 may provide for improved repeatability and accuracy to measurements made with the thermometer. The thermometer 20 including the IR image sensor 130 may also be used to train users so that they are able to develop an efficient and accurate technique for using a tympanic thermometer.

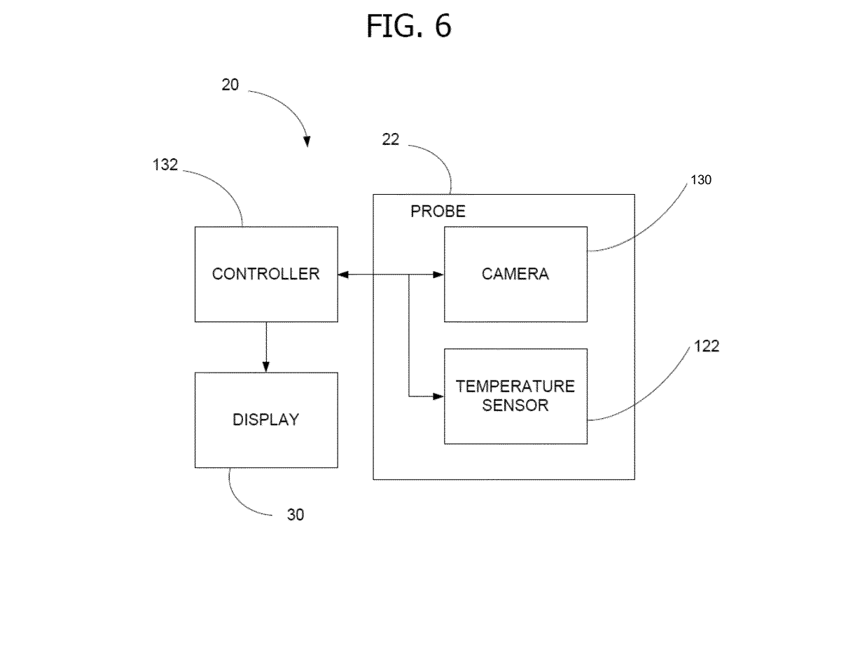

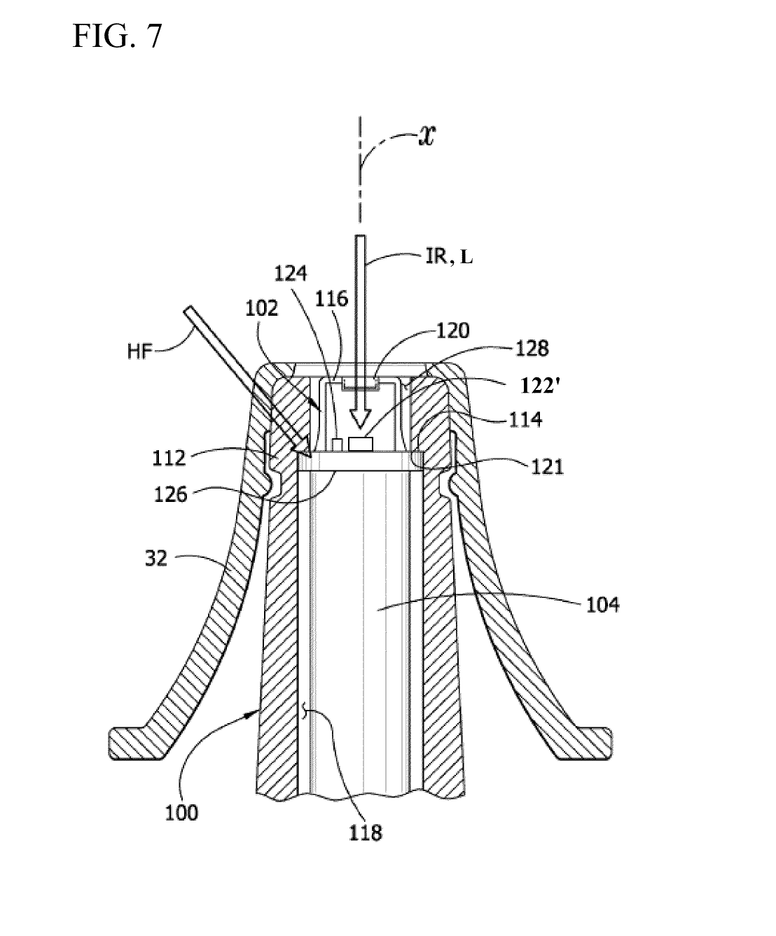

Referring now to FIG. 7, in another embodiment the thermometer 20 may include an IR temperature/image sensor 122′ that senses electromagnetic radiation emitting from the user's anatomy (e.g., the inner ear) and generates data that is indicative of both the temperature of the subject (e.g., temperature data) and images of the subject's anatomy (e.g., image data). That is, the temperature/image data generated by the IR sensor 122′ may be used as both temperature data and image data by the controller 132. In the embodiment of FIG. 7, controller 132 (FIG. 6) is configured to use the data generated by the IR temperature/image sensor 122′ to compute the body temperature and the anatomical images for display on the display 30. The controller 132 may display the temperature image and the anatomical image on the display 30 in a manner similar to that shown in FIGS. 11 and 12, or in another manner.

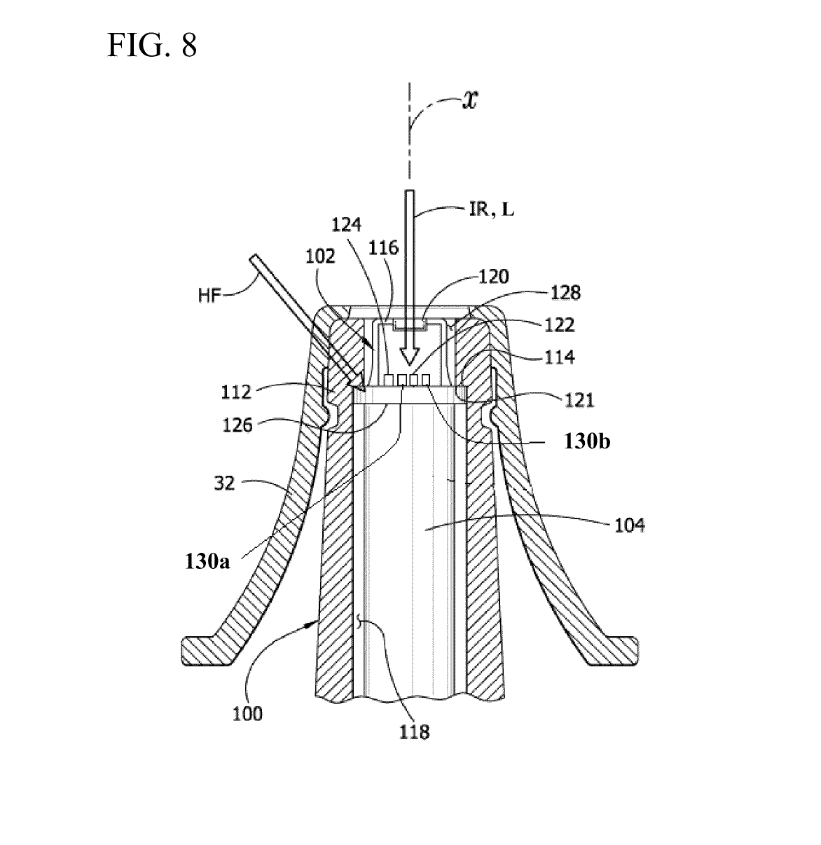

Referring to FIG. 8, in another embodiment the thermometer 20 includes both an IR image sensor 130a and a visual light image sensor 130b. The illustrated thermometer 20 also includes the temperature sensor 122 (e.g., an IR temperature sensor), although the temperature sensor 122′, as described in reference to the embodiment shown in FIG. 7, may be used to generate both temperature data and image data. In an example of such an embodiment, the thermometer 20 may include a switch (not shown) to allow a user to select between two modes of operation: an IR imaging mode, in which the controller 132 receives IR image data from the IR image sensor 130a, computes an anatomical image based on the received IR image data, and generates an IR anatomical image on the display 30, such as shown in FIGS. 11 and 12; and a visual imaging mode, in which the controller 132 receives visual image data from the visual image sensor 130b, computes a visual anatomical image based on the received visual image data, and generates a visual image on the display, such as shown in FIGS. 9 and 10.

In another example of this embodiment, the controller 132 processes the data outputs of the IR image sensor 130a and the visual light image sensor 130b to simultaneously generate IR and visual anatomical images 170 on the display 30. For example, the visual image may overlay the IR image, or vice-versa. It is further contemplated that the visual anatomical image and the IR anatomical image may be displayed side-by-side on the display 30.

Anatomical imaging addresses problems in tympanic thermometry, including blind placement, wax in the ear canal, wax on the probe tip, improper insertion depth, improper insertion angle, and missing or damaged (e.g., tears, holes, haze) probe cover. The tympanic thermometer 20 having an image sensor 130 and a display 30 for displaying the anatomy of the subject eliminates the blind technique for placement to allow the practitioner to determine whether the probe 22 is properly inserted within the subject's ear. In addition, the thermometer 20 allows a practitioner to recognize whether the probe cover 32 is present and, if so, whether the probe cover is clean and undamaged. The thermometer is also useful to the practitioner for identifying possible ear infections.

Advantageously, a film commonly required for infection control on probe covers can now be eliminated because the camera (i.e., image sensor 130) provides detection of foreign material on the lens or the probe cover, which enables warning the user as soon as the device is turned on. Warning the user provides an opportunity for the user to first clean the lens or replace the probe cover before proceeding with a temperature measurement. As such, aspects of the invention permit use of lower cost and simpler probe covers, much like speculums for otoscopes.

In addition to acting as a visual placement aid, in another embodiment the controller 132 may also be configured (i.e., programmed) for automatic detection of proper placement of the probe 22 in the orifice (e.g., ear canal) of the subject, automatic detection and alert for wax in the ear canal, and automatic detection and indication of proper insertion depth of the probe. With respect to automatic detection of placement, those of ordinary skill in the art are familiar with image processing software for identifying certain shapes, sizes, and the like within regions of interest of an image. Such image processing software is useful for identifying the hottest spot within the ear canal and triggering the temperature measurement when that spot is in the center of the camera's field of view. Moreover, image processing software can be used to enhance any of the uses of the captured video or other images.

In another embodiment, the processor of controller 132 is programmed to identify a first condition wherein the video images indicate that the probe 22 is received in probe cover 32 but not inserted into the subject, and a second condition wherein the video images indicate that the probe 22 is received in probe cover 32 and inserted into the subject. The processor can be programmed to provide an indication, such as a read-out on the display 30 of the thermometer 20, notifying the practitioner which condition is being detected. However, the indications can be provided in other ways such as audible indications without departing from the scope of the invention.

In another embodiment, the processor can also be programmed to activate the temperature sensor 122 to measure the temperature of the subject only after the processor identifies the second condition wherein the probe 22 is received in the probe cover 32 and inserted into the subject. This improves the accuracy of the thermometer 20 because power is not supplied to the temperature sensor 122 until the probe 22 is properly inserted into the subject. Also, external effects on the temperature sensor 122 are minimized making the temperature readings produced by the temperature sensor more accurate.

In the same embodiment, the processor can be programmed to trigger an alarm when the processor identifies the first condition wherein the probe 22 is inserted into the subject without a probe cover. For instance a flashing light may be displayed on the display 30 of the thermometer 20 indicating to the practitioner that the probe 22 has been improperly inserted into the subject. If the processor identifies this first condition, the thermometer 20 will continue to prevent power from being supplied to the temperature sensor 122 so that the thermometer cannot measure the temperature of the subject. The display 30 may further prompt the practitioner to clean the probe 22 before properly reinserting the probe into the patient with a probe cover. By alerting the practitioner to clean the probe 22 and place a probe cover over the probe before the thermometer 20 is used again, the potential contamination that occurs when the thermometer is used after it has been inserted into a subject without a probe cover is minimized.

Having described embodiments of the invention in detail, it will be apparent that modifications and variations are possible without departing from the scope of the invention defined in the appended claims.

Those skilled in the art will note that the order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular operation before, contemporaneously with, or after another operation is within the scope of aspects of the invention.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A thermometer for measuring a temperature of a subject comprising:
a probe adapted to be inserted into an orifice of the subject;
an electromagnetic radiation sensor at the probe for sensing electromagnetic radiation within the orifice of the subject, the electromagnetic radiation sensor being configured to generate data indicative of both the temperature of the subject and one or more anatomical images of the subject;
a visual display; and
a controller, including a processor, in communication with the electromagnetic radiation sensor and the visual display, the controller configured to:
receive the generated data from the electromagnetic radiation sensor;
compute the temperature of the subject based on the received generated data;
generate a temperature image on the display indicative of the computed temperature of the subject;
compute one or more anatomical images of the subject based on the received generated data;
generate the one or more computed anatomical images of the subject on the display.

2. The thermometer set forth in claim 1, wherein the electromagnetic radiation sensor comprises an infrared sensor configured to sense infrared radiation within the orifice of the subject, wherein the infrared sensor is configured to generate said data indicative of both the temperature of the subject and one or more anatomical images of the subject.

3. The thermometer set forth in claim 2, wherein said infrared sensor comprises a first infrared sensor configured to generate temperature data indicative of the temperature of the subject, and a second infrared sensor, separate from the first infrared sensor, configured to generate image data indicative of one or more anatomical images of the subject.

4. The thermometer set forth in claim 2, wherein said infrared sensor comprises a single infrared sensor configured to generate temperature data indicative of the temperature of the subject, and image data indicative of one or more anatomical images of the subject.

5. The thermometer set forth in claim 1, wherein the electromagnetic radiation sensor comprises a first electromagnetic radiation sensor configured to sense visible light radiation reflecting from the anatomy of the subject and generate image data indicative of one or more visible anatomical images of the subject, and a second electromagnetic radiation sensor configured to sense infrared radiation emitting from the anatomy of the subject and generate temperature data indicative of the temperature of the subject.

6. The thermometer set forth in claim 1, further comprising a reference temperature sensor configured to generate reference temperature data indicative of the temperature of the probe, wherein the controller is configured to receive the reference temperature data and compute the temperature of the subject based on the reference temperature data.

7. The thermometer of claim 1, wherein the image sensor has a field of view and wherein the controller is configured for processing the image to detect an obstruction within the field of view of the camera.

8. The thermometer of claim 1, wherein the controller is configured for processing the received data to detect insertion of the probe in the subject at a desired depth.

9. The thermometer of claim 1, wherein the controller is configured for processing the received data to detect a desired placement of the probe and to automatically trigger a temperature measurement.

10. The thermometer of claim 1, wherein the controller is configured for determining when the probe is received in a probe cover and not inserted into the subject.

11. The thermometer of claim 1, wherein the controller is configured for determining when the probe is received in a probe cover and inserted into the subject.

12. The thermometer of claim 11, wherein the controller is programmed to activate the electromagnetic radiation sensor to receive data from the sensor only after the controller determines that the probe is received in the probe cover and inserted into the subject.

13. The thermometer of claim 1, wherein the controller is configured for causing the display to indicate one or more of the following alerts to a user: clean ear; clean tip; probe cover missing; probe cover damaged; ear infection; and press button.

14. The thermometer of claim 1, further comprising a wireless transmitter for transmitting the data to the display, wherein the display comprises a remote display.

15. The thermometer of claim 1, wherein the controller is configured for overlaying the temperature image and the anatomical image on the display.

16. The thermometer of claim 1, wherein the image sensor has a field of view, the thermometer further comprising a light source for illuminating at least a portion of the field of view of the camera.

17. A tympanic thermometer for measuring a temperature of a subject comprising:
a handle sized and shaped to be held by a user;
a visual display on handle;
a probe extending outward from the handle and adapted to be inserted into an ear canal of the subject;
an infrared radiation temperature sensor in the probe for sensing infrared radiation emitting from a tympanic membrane of the subject when the probe is inserted in the ear canal of the subject, the infrared radiation temperature sensor being configured to generate temperature data indicative of the temperature of the subject;
a visible light image sensor at the probe for sensing visible light radiation reflecting from ear canal when the probe is inserted in the ear canal of the subject, the visible light image sensor being configured to generate anatomical image data indicative of the anatomy of the subject; and
a controller, including a processor, in communication with the infrared radiation temperature sensor, the visible light sensor, and the visual display, the controller configured to:
receive the generated temperature data from the infrared radiation temperature sensor;
compute the temperature of the subject based on the received temperature data;
generate a temperature image on the display indicative of the computed temperature of the subject;
receive the generated anatomical image data from the visible light image sensor; and
generate one or more anatomical images of the subject on the display based on the received image data.

18. The tympanic thermometer set forth in claim 17, further comprising a light source configured to illuminate the ear canal when the probe is inserted in the ear canal.

19. The tympanic thermometer set forth in claim 17, further comprising an infrared radiation image sensor at the probe for sensing infrared radiation emitting from the tympanic membrane when the probe is inserted in the ear canal of the subject, the infrared radiation image sensor being configured to generate anatomical image data indicative of the anatomy of the subject, wherein the controller is configured to:
receive the generated image data from the infrared radiation image sensor;
compute one or more anatomical images of the subject based on the received image data from the infrared radiation image sensor;
generate the one or more computed anatomical images of the subject on the display.

20. The tympanic thermometer set forth in claim 19, wherein the thermometer further comprises a switch configured to allow the user to select between a first mode, in which the one or more anatomical images based on the image data from infrared radiation image sensor are displayed on the display, and a second mode, in which the one or more anatomical images based on the image data from the visible light image sensor are displayed on the display.

21. A thermometer for measuring a temperature of a subject comprising:
a probe adapted to be inserted into an orifice of the subject, said probe having a film-less probe cover;
an electromagnetic radiation sensor at the probe for sensing electromagnetic radiation within the orifice of the subject, the electromagnetic radiation sensor being configured to generate data indicative of both the temperature of the subject and one or more anatomical images of the subject;
a visual display; and
a controller, including a processor, in communication with the electromagnetic radiation sensor and the visual display, the controller configured to:
receive the generated data from the electromagnetic radiation sensor;
compute the temperature of the subject based on the received generated data;
generate a temperature image on the display indicative of the computed temperature of the subject;
compute one or more anatomical images of the subject based on the received generated data;
generate the one or more computed anatomical images of the subject on the display.
